(19) United States
(12) Patent Application Publication
(10) Pub. No.: US 2007/0245023 A1
(43) Pub. Date: Oct. 18, 2007

(54) Method and system for locating storage devices in a storage facility with an inband enclosure node

(76) Inventors: Lokesh M. Gupta, Tucson, AZ (US); Michael J. Jones, Cedar Park, TX (US)

Correspondence Address: DILLON & YUDELL, LLP, 8911 N CAPITAL OF TEXAS HWY, SUITE 2110, AUSTIN, TX, 78759, US

(21) Appl. No.: 11/388,851

(22) Filed: Mar. 24, 2006

(51) Int. Cl. G06F 15/173

(52) U.S. Cl. 709/226

(57) ABSTRACT

A method for performing locating storage devices in a storage facility with an inband enclosure node is disclosed. The method includes requesting that a first device adapter identify a first port on which it is communicating to a processor ordering the processor to identify a first fibre channel loop on which the first device adapter is communicating to a storage enclosure. A list of disks and addresses on the first port and a second port is demanded from the first adapter and querying from the storage enclosure a list of addresses for one or more disk slots on the first fiber channel loop and a second fibre channel loop is performed. Storage devices in the storage facility with the inband enclosure node are located by matching the addresses from the querying step and the demanding step.

### BACKGROUND OF THE INVENTION

1. Technical Field

The present invention relates in general to storage devices and in particular to performing maintenance on storage devices. Still more particularly, the present invention relates to a system, method and computer program product for locating storage devices in a storage facility with an inband enclosure node.

2. Description of the Related Art

Fibre Channel is a gigabit-speed network technology used primarily for Storage Networking. Fibre Channel is standardized by the T11 Technical Committee of the InterNational Committee for Information Technology Standards (INCITS), an American National Standard Institute (ANSI) accredited standards committee. Fibre Channel started for use primarily in the supercomputer field, but has become the standard connection type for storage area networks in enterprise storage. Despite its name, Fibre Channel signaling can run on both twisted-pair copper wire and fiber optic cables.

The use of fibre channel started in 1988, with approval of a standard by the American National Standards Institute in 1994, as a way to simplify the then-standard systems in use for similar roles. Previous solutions used a massive 50-pair cable and gigantic connectors, and had limited cable lengths. The developers of fibre channel were primarily interested in simplifying the connections and increasing the lengths, as opposed to increasing speeds. Later, interest broadened to focus on addressing higher speeds and far greater numbers of connected devices. The introduction of greater numbers of devices has introduced resulting difficulties.

In a fibre channel storage facility, an administrator periodically needs to locate a particular storage device (such as a disk) for maintenance purposes (for example, to replace a faulty disk). Typically, the serial number of the disk is known, but there can be many hundreds of disks in multiple storage enclosures, and locating the disk with a label containing the correct serial number can be a time consuming exercise.

In the prior art, there are two known solutions for locating disks in a fibre channel storage facility. First, an administrator can conduct a disk-by-disk search, where the administrator looks at the label on each and every disk to find the disk with the correct serial number. The drawback to such a search is that the search can consume tremendous quantities of time, especially if the storage facility contains a large number of disks. Second, the storage facility can instruct the Distributed Data Manager (DDM) to flash an identify light emitting diode (LED) on the correct disk. The drawbacks of the second method are that it still requires contact with each disk, and, if the disk is non-functional, then the disk may not be able to flash an LED. Either prior-art solution consumes excessive amounts of time.

### SUMMARY OF THE INVENTION

A method for performing locating storage devices in a storage facility with an inband enclosure node is disclosed. The method includes requesting that a first device adapter identify a first port on which it is communicating to a processor ordering the processor to identify a first fibre channel loop on which the first device adapter is communicating to a storage enclosure. A list of disks and addresses on the first port and a second port is demanded from the first adapter and querying from the storage enclosure a list of addresses for one or more disk slots on the first fiber channel loop and a second fibre channel loop is performed. Storage devices in the storage facility with the inband enclosure node are located by matching the addresses from the querying step and the demanding step.

### BRIEF DESCRIPTION OF THE DRAWINGS

The novel features believed characteristic of the invention are set forth in the appended claims. The invention itself, however, as well as a preferred mode of use, further objects and advantages thereof, will best be understood by reference to the following detailed descriptions of an illustrative embodiment when read in conjunction with the accompanying drawings, wherein:

FIG. 1A depicts a block diagram of the arrangement of a storage system and a data processing system with which the present invention of a method, system and computer program product for locating storage devices in a storage facility with an inband enclosure node may be performed;

FIG. 1B depicts a block diagram of a storage system with which the present invention of a method, system and computer program product for locating storage devices in a storage facility with an inband enclosure node may be performed; and

FIG. 2 is a high-level logical flowchart of a process for locating storage devices in a storage facility with an inband enclosure node in accordance with a preferred embodiment of the present invention.

### DETAILED DESCRIPTION OF THE PREFERRED EMBODIMENT

The present invention provides a method, system, and computer program product for locating storage devices in a storage facility with an inband enclosure node.

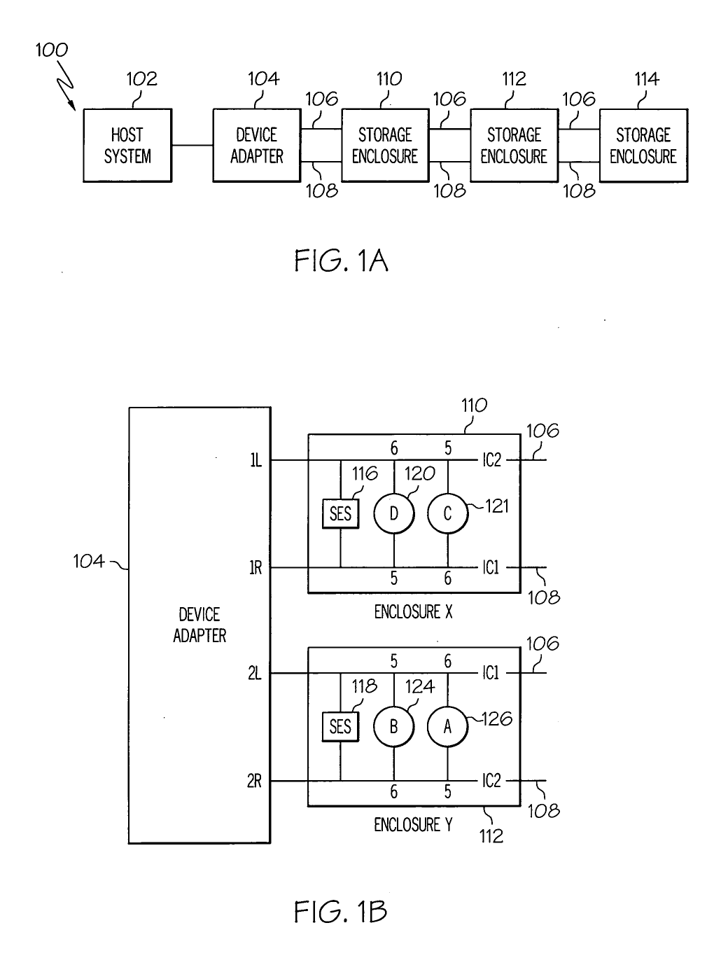

With reference now to the figures, and in particular to FIG. 1, a block diagram of a storage system with which the present invention of a method, system and computer program product for locating storage devices in a storage facility with an inband enclosure node may be performed is illustrated. A storage network 100 includes a host system 102 connected to a device adapter 104. Device adapter 104 connects to a first storage enclosure 110, a second storage enclosure 112 and a third storage enclosure 114 across a first fibre channel loop 106 and a second fibre channel loop 108.

Referring now to FIG. 1B, a storage system with which the present invention of a method, system and computer program product for locating storage devices in a storage facility with an inband enclosure node may be performed is depicted. In the preferred embodiment depicted in FIG. 1B, device adapter 104 operates four ports. A first left port (1L) connects device adapter 104 to first storage enclosure 110 across first fibre channel loop 106, which loop first storage enclosure 110 identifies as IC2. A first right port (1R) connects device adapter 104 to first storage enclosure 110 across second fibre channel loop 108, which loop first storage enclosure 110 identifies as IC1. A second left port (2L) connects device adapter 104 to second storage enclosure 112 across first fibre channel loop 106, which loop second storage enclosure 112 identifies as IC1.

A second left port (2L) connects device adapter 104 to second storage enclosure 112 across second fibre channel loop 108, which loop second storage enclosure 112 identifies as IC2. The combination of first left port 1L and first right port 1R is called a dual loop, as is the combination of second left port 2L and second right port 2R. There is no set relationship between ports of device adapter 104 and enclosure loops. Device adapter 104 can connect an L port to either IC1 or IC2. In the above diagram, first disk 120 (Disk D) has claimed arbitrated loop physical address (ALPA)=6 on IC2 of first enclosure 110 (EnclosureX), and this loop is attached to first left port 1L.

Each of first storage enclosure 110 and second storage enclosure 112 accomodates both first fibre channel loop 106 and second fibre channel loop 108, which are attached to each of a first disk 120 and a second disk 122 within first storage enclosure 110 as well as a first disk 124 and a second disk 126 within second storage enclosure 112. In the embodiment illustrated in FIG. 1B, first storage enclosure 110 and second storage enclosure 112 also contain a first SCSI Enclosure Services (SES) processor 116 and a second SES processor 118, respectively, which are also attached to each of first fibre channel loop 106 and second fibre channel loop 108.

Device adapter 104 gathers data as to the fibre channel arbitrated loop physical address (ALPA) that each of first disk 120 and second disk 122 within first storage enclosure 110 as well as the ALPA that each of first disk 124 and second disk 126 within second storage enclosure 112 has obtained on first fibre channel loop 106 attached to first left port 1L and second left port 2L and second fibre channel loop 108 attached to first right port 1R and second right port 2R. Each of first disk 120 and second disk 122 within first storage enclosure 110 as well as first disk 124 and second disk 126 within second storage enclosure 112 has a unique ALPA on each of first fibre channel loop 106 and second fibre channel loop 108 and may receive different ALPAs on each loop. It is also possible for there to be multiple dual loops attached to a device adapter. First SES processor 116 and a second SES processor 118 gather data on the ALPAs that first disk 120 and second disk 122 and first disk 124 and second disk 126, in each of their slots have uniquely, at least with respect to the loop, claimed on first fibre channel loop 106 and second fibre channel loop 108. respectively.

Device adapter 104 sees first disk 120, second disk 122, first disk 124, second disk 126, first SES processor 116 and second SES processor 118 as nodes on first fibre channel loop 106 and second fibre channel loop 108 and presents them to host system 102 as resources. Device adapter 104 does not know in which of first storage enclosure 110 and second storage enclosure 112 a disk among the first disk 120 and second disk 122 and first disk 124 and second disk 126 is physically located. Device adapter 104 gathers data as to which adapter port among first left port 1L and second left port 2L first right port 1R and second right port 2R is communicating to a particular SES processor from among first SES processor 116 and second SES processor 118.

Likewise, first SES processor 116 and a second SES processor 118 gather data as to which fibre channel loop among first fibre channel loop 106 and second fibre channel loop 108 device adapter 104 is using to communicate to first storage enclosure 110 and second storage enclosure 112. Using the information gathered above, the present invention provides a method by which, for a particular disk among the first disk 120 and second disk 122 and first disk 124 and second disk 126, device adapter 104 matches the ALPAs known to device adapter 104 to the correct set of ALPAs known to first storage enclosure 110 or second storage enclosure 112 and thereby determines the physical location of the disk.

An advantage of the method of the present invention is that the disk can be located very quickly because the enclosure and slot number are both known. The present invention is also applicable in situations in which there are multiple enclosures on a dual loop and also if some of the disks are only connected to a single dual loop. A utility of host system 102 derives the physical location of a disk in an enclosure according to a method represented by the following pseudocode:

1. Ask the device adapter for a list of SES nodes. For each SES node:
1.0 Find out which device adapter ports are attached to which enclosure loops by doing the following:
1.1 Ask the device adapter which port it is communicating to the SES node through
1.2 Ask the SES node which fibre channel loop the adapter is communicating to the enclosure through.
1.3 Assume that the partner adapter port is attached to the other loop (see example)

2. Ask the adapter for a list of disks and their ALPAs on the adapter ports identified in step 1.

3. Ask the enclosure for a list of ALPAs for each disk slot on both loops.

4. Match the ALPA list from the adapter to the ALPA list from the enclosure, ensuring that the correct loop is matched up.

As an example, consider a case where, in the system represented by FIG. 1B, the pseudocode described above executes with results as follows:

1.1. Device adapter reports it is communicating to the SES node through the 1L port.

1.2. SES node in EnclosureX reports that the adapter is communicating to the IC2 loop.

1.3. Therefore 1L is connected to IC2 and 1R is connected to IC1.

2. The device adapter reports the following ALPA map for its 1L/1R ports:

Disk D has ALPA=6 on 1L loop

Disk D has ALPA=5 on 1R loop

Disk C has ALPA=5 on 1L loop

Disk C has ALPA=6 on 1R loop.

3. EnclosureX reports the following ALPA map for its disks:

Disk in slot1 has ALPA=5 on IC1 loop

Disk in slot1 has ALPA=6 on IC2 loop

Disk in slot2 has ALPA=6 on IC1 loop

Disk in slot2 has ALPA=5 on IC2 loop

4. Match disks to EnclosureX:

Disk D has ALPA=6 on 1L loop and 1L is connected to IC2.

The only slot in the enclosure ALPA map with ALPA=6 on IC2 is slot 1.

Therefore DiskD is in enclosureX slot 1.

Disk C has ALPA=6 on 1R loop and and 1R is connected to IC1.

The only slot in the enclosure ALPA map with ALPA=6 on IC1 is slot 2. Therefore DiskC is in enclosureX slot2.

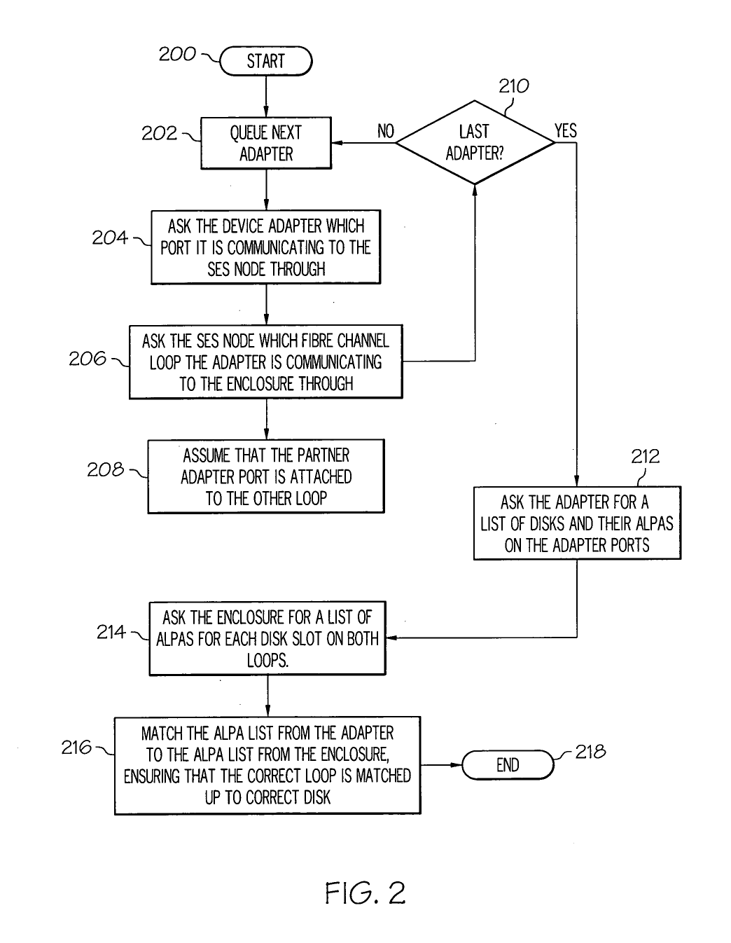

Turning now to FIG. 2, a high-level logical flowchart of a process for locating storage devices in a storage facility with an inband enclosure node in accordance with a preferred embodiment of the present invention is depicted. The process starts at step 200 and then proceeds to step 202, which depicts host system 102 queueing a next device adapter, for example device adapter 104. The process next moves to step 204, which illustrates host system 102 requesting that device adapter 104 identify the port on which it is communicating to an SES processor, for example SES processor 116. The process then proceeds to step 206. Step 206 illustrates host system 102 requesting that SES processor 116 identify whether device adapter 104 is communicating to first storage enclosure 110 through first fibre channel loop 106 or second fibre channel loop 108. The process then proceeds to step 208, which depicts host system 102 assuming that the port not indicated in step 204 is communicating through the fibre channel loop from among first fibre channel loop 106 and second fibre channel loop 108 which was not indicated for communication by adapter 104 in step 206.

The process next moves to step 210. Step 210 illustrates host system 102 determining whether the device adapter 104 queued in step 202 is the last device adapter requiring query. If host system 102 determines that the device adapter 104 queued in step 202 is not the last device adapter requiring query, then the process returns to step 202. If host system 102 determines that the device adapter 104 queued in step 202 is the last device adapter requiring query, then the process proceeds to step 212, which depicts host system 102 requesting that device adapter 104 submit a list of all disks on its adapter ports. The process next moves to step 214. Step 214 illustrates host system 102 requesting that first storage enclosure 110 submit a list of ALPAs for each disk slot on both of first fibre channel loop 106 and second fibre channel loop 108.

The process next proceeds to step 216, which illustrates host system 102 matching an ALPA list received in step 214 to an ALPA list received in step 212, ensuring that the correct loop from among first fibre channel loop 106 and second fibre channel loop 108 is matched to each disk. The process then ends at step 218.

While the invention has been particularly shown as described with reference to a preferred embodiment, it will be understood by those skilled in the art that various changes in form and detail may be made therein without departing from the spirit and scope of the invention. It is also important to note that although the present invention has been described in the context of a fully functional computer system, those skilled in the art will appreciate that the mechanisms of the present invention are capable of being distributed as a program product in a variety of forms, and that the present invention applies equally regardless of the particular type of signal bearing media utilized to actually carry out the distribution. Examples of signal bearing media include, without limitation, recordable type media such as floppy disks or CD ROMs and transmission type media such as analog or digital communication links.

What is claimed is:

1. A method for performing locating storage devices in a storage facility with an inband enclosure node, said method comprising:
requesting that a first device adapter identify a first port on which it is communicating to a processor;
ordering said processor to identify a first fibre channel loop on which said first device adapter is communicating to a storage enclosure;
demanding from said first adapter a list of disks and addresses on said first port and a second port;
querying from said storage enclosure a list of addresses for one or more disk slots on said first fiber channel loop and a second fibre channel loop; and
locating storage devices in said storage facility with said inband enclosure node by matching said addresses from said querying step and said demanding step.

2. The method of claim 1, further comprising assuming that said second port is attached to said second fibre channel loop.

3. The method of claim 1, wherein said step of ordering said processor to identify said first fibre channel loop on which said first device adapter is communicating to said storage enclosure further comprises ordering an SES processor to identify said first fibre channel loop on which said first device adapter is communicating to said storage enclosure.

4. The method of claim 1, wherein said step of requesting that said first device adapter identify said first port on which it is communicating to a processor further comprises requesting that said first device adapter identify said first port on which it is communicating to said SES processor.

5. The method of claim 1, wherein said step of locating storage devices in said storage facility with said inband enclosure node by matching said addresses from said querying step and said demanding step further comprises matching corresponding ALPAs.

6. The method of claim 1, wherein said step of demanding from said first adapter said list of disks and addresses on said first port and said second port further comprises demanding a first list of ALPAs.

7. The method of claim 1, wherein said step of querying from said storage enclosure said list of addresses for one or more disk slots on said first fiber channel loop and said second fibre channel loop further comprises demanding a second list of ALPAs.

8. A system for performing locating storage devices in a storage facility with an inband enclosure node, said system comprising:
means for requesting that a first device adapter identify a first port on which it is communicating to a processor;
means for ordering said processor to identify a first fibre channel loop on which said first device adapter is communicating to a storage enclosure;
means for demanding from said first adapter a list of disks and addresses on said first port and a second port;
means for querying from said storage enclosure a list of addresses for one or more disk slots on said first fiber channel loop and a second fibre channel loop; and
means for locating storage devices in said storage facility with said inband enclosure node by matching said addresses from said querying step and said demanding step.

9. The system of claim 1, further comprising means for assuming that said second port is attached to said second fibre channel loop.

10. The system of claim 1, wherein said means for ordering said processor to identify said first fibre channel loop on which said first device adapter is communicating to said storage enclosure further comprises means for ordering an SES processor to identify said first fibre channel loop on which said first device adapter is communicating to said storage enclosure.

11. The system of claim 1, wherein said means for requesting that said first device adapter identify said first port on which it is communicating to a processor further comprises means for requesting that said first device adapter identify said first port on which it is communicating to said SES processor.

12. The system of claim 1, wherein said means for locating storage devices in said storage facility with said inband enclosure node by matching said addresses from said querying step and said demanding step further comprises means for matching corresponding ALPAs.

13. The system of claim 1, wherein said means for demanding from said first adapter said list of disks and addresses on said first port and said second port further comprises means for demanding a first list of ALPAs.

14. The system of claim 1, wherein said means for querying from said storage enclosure said list of addresses for one or more disk slots on said first fiber channel loop and said second fibre channel loop further comprises means for demanding a second list of ALPAs.

15. A machine-readable medium having a plurality of instructions processable by a machine embodied therein, wherein said plurality of instructions, when processed by said machine, causes said machine to perform a method, comprising:
requesting that a first device adapter identify a first port on which it is communicating to a processor;
ordering said processor to identify a first fibre channel loop on which said first device adapter is communicating to a storage enclosure;
demanding from said first adapter a list of disks and addresses on said first port and a second port;
querying from said storage enclosure a list of addresses for one or more disk slots on said first fiber channel loop and a second fibre channel loop; and
locating storage devices in said storage facility with said inband enclosure node by matching said addresses from said querying step and said demanding step.

16. The machine-readable medium of claim 15, said method further comprising assuming that said second port is attached to said second fibre channel loop.

17. The machine-readable medium of claim 15, wherein said step of ordering said processor to identify said first fibre channel loop on which said first device adapter is communicating to said storage enclosure further comprises ordering an SES processor to identify said first fibre channel loop on which said first device adapter is communicating to said storage enclosure.

18. The machine-readable medium of claim 15, wherein said step of requesting that said first device adapter identify said first port on which it is communicating to a processor further comprises requesting that said first device adapter identify said first port on which it is communicating to said SES processor.

19. The machine-readable medium of claim 15, wherein said step of locating storage devices in said storage facility with said inband enclosure node by matching said addresses from said querying step and said demanding step further comprises matching corresponding ALPAs.

20. The machine-readable medium of claim 15, wherein said step of demanding from said first adapter said list of disks and addresses on said first port and said second port further comprises demanding a first list of ALPAs.
